(19) United States
(12) Patent Application Publication
(10) Pub. No.: US 2011/0262175 A1
(43) Pub. Date: Oct. 27, 2011

(54) IMAGE FORMING APPARATUS FOR CHANGING EXHAUST AIR DIRECTION

(75) Inventor: Yoshihiro TAKAHASHI, Shizuoka (JP)

(73) Assignees: Toshiba Tec Kabushiki Kaisha, Tokyo (JP); Kabushiki Kaisha Toshiba, Tokyo (JP)

(21) Appl. No.: 13/048,745

(22) Filed: Mar. 15, 2011

Related U.S. Application Data
(60) Provisional application No. 61/326,563, filed on Apr. 21, 2010.

(51) Int. Cl. G03G 21/20; B23P 23/00

(52) U.S. Cl. 399/92; 29/401.1

(57) ABSTRACT

An image forming apparatus according to an embodiment includes: a housing including an exhaust port; a pocket-and-duct which is attached to or detached from the housing; and an attaching portion of the pocket-and-duct.

### CROSS-REFERENCE TO RELATED APPLICATION

This application is based upon and claims the benefit of priority from Provisional U.S. Application 61/326563 filed on Apr. 21, 2010, the entire contents of which are incorporated herein by reference.

### FIELD

Embodiments described herein relate generally to an image forming apparatus for regulating exhaust air and noise generated by a copying machine, a printer, or the like.

### BACKGROUND

There is an image forming apparatus provided with an external duct dedicated to reducing noise that is generated during an operation of the image forming apparatus, outside an exhaust port of the image forming apparatus. On the other hand, a user desires to change the direction of air exhausted from the exhaust port depending on where the image forming apparatus is installed in a room.

Accordingly, the development of an image forming apparatus capable of easily changing the direction of air exhausted from an exhaust port is desirable.

### BRIEF DESCRIPTION OF THE DRAWINGS

FIG. 1 is a schematic perspective view of a printer having a cover attached at a pocket position according to a first embodiment from a rear view.

FIG. 2 is a schematic perspective view of the cover according to the first embodiment from the rear view.

FIG. 3 is a schematic perspective view of another example of the cover according to the first embodiment from the rear view.

FIG. 4 is a schematic perspective view of the printer having the cover attached so as to cause an opening of a duct hole to face downward according to the first embodiment from the rear view.

FIG. 5 is a schematic perspective view of the printer having the cover attached so as to cause the opening of the duct hole to face to the left according to the first embodiment from the rear view.

FIG. 6 is a schematic perspective view of the printer having the cover attached so as to cause the opening of the duct hole to face to the right according to the first embodiment from the rear view.

FIG. 7 is a schematic perspective view of the cover which is attached or detached by an adhesive tape according to the first embodiment from the rear view.

FIG. 8 is a schematic perspective view of the cover which is attached or detached in a fit-in type according to the first embodiment from the rear view.

FIG. 9 is a schematic perspective view of a cover according to a second embodiment from a rear view.

FIG. 10 is a schematic perspective view of a printer having the cover attached so as to cause an opening of a duct hole to face downward according to the second embodiment from the rear view.

### DETAILED DESCRIPTION

According to an embodiment, an image forming apparatus includes: a housing including an exhaust port; a pocket-and-duct which is attached to or detached from the housing; and an attaching portion of the pocket-and-duct.

Hereinafter, embodiments will be described.

### First Embodiment

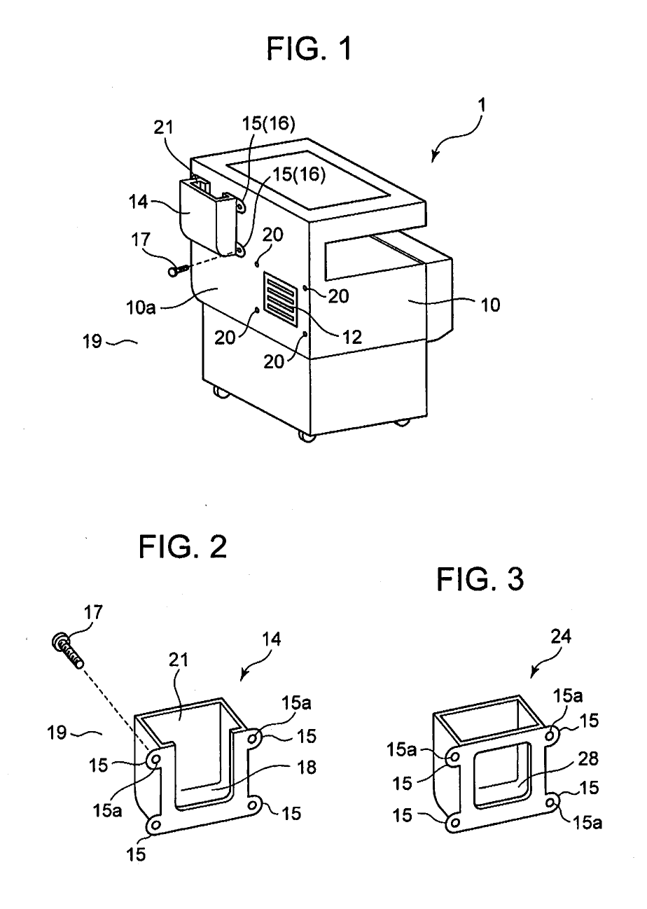

FIG. 1 is a schematic perspective view of a printer 1 which is an image forming apparatus according to a first embodiment from a rear view. The printer 1 has a duct hole 12 which is an exhaust port on a housing rear face 10a thereof. The printer 1 has a cover 14 which is a pocket-and-duct at a pocket position of the housing rear face 10a so as to be attachable and detachable.

As illustrated in FIG. 2, the cover 14 has four pedestals 15 each of which has a screw hole 15a. The four screw holes 15a form a square. The cover 14 is made of, for example, plastic and is formed integrally with the pedestals 15. The cover 14 includes a cut-out portion 18 which is a conduction portion on an attaching side of a housing 10. The shape of the cover 14 is not limited, and for example, as illustrated by another example of FIG. 3, a cut-out portion 28 on the rear face of the cover 24 may be formed in a hole shape.

By screws 17, the pedestals 15 of the cover 14 are screwed to screw holes 16 provided in the housing 10 at the pocket position of the housing rear side 10a. In the vicinity of the duct hole 12 of the housing rear side 10a, screw holes 20 are formed in the same arrangement as that of the screw holes at the pocket position. The screw holes 15a, 16 and 20 and the screws 17 form a screw unit as the attaching portion.

At the pocket position, the cover 14 is attached so that an opening portion 21 thereof faces upward. In the cover 14 attached at the pocket position, as needed, instruction manuals, maintenance records, and the like are put.

In order to remove heat generated by, for example, an exposure unit or a fixing unit inside the housing 10, the printer 1 discharges air inside the housing 10 to the outside from the duct hole 12. Moreover, as well as the air, driving sound inside the housing 10 leaks out from the duct hole 12. Accordingly, when the printer 1 is installed in the office, depending on the installation position, an exhaust direction of the air from the duct hole 12 needs to be changed.

For example, when the printer 1 is installed at a place slightly far from a desk in the office, both the exhaust air and noise from the duct hole 12 are not significant problems. Therefore, the cover 14 is attached at the pocket position and functions as the pocket in which materials are put. Here, since the duct hole 12 is open, exhaust air and noise from the printer 1 disperse in all directions.

On the other hand, for example, when the printer 1 is installed near the desk in the office, there is a need to cause exhaust air and noise from the duct hole 12 not to be directed toward the desk. Therefore, when the printer 1 is installed, the cover 14 is moved from the pocket position to be attached to the duct hole 12 so as to cause exhaust air and noise from the printer 1 to be directed toward a preferable direction. To move and attach the cover 14, the screw 17 is unscrewed from the screw hole 16, and the cover 14 detached from the pocket position is screwed to the screw holes 20 in the vicinity of the duct hole 12. The exhaust air and noise from the duct hole 12 passes through the cut-out portion 18 and the direction thereof is changed along the inner wall of the cover 14.

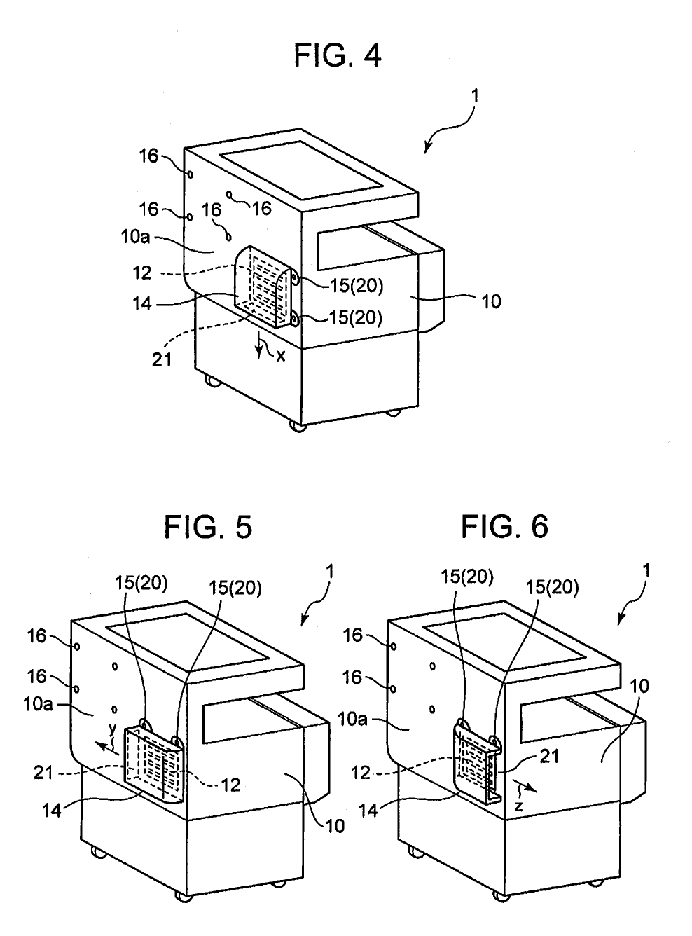

For example, when the desk exists on the housing rear face 10a side of the printer 1, as illustrated in FIG. 4, the opening portion 21 of the cover 14 faces downward in the arrow x direction. Accordingly, the exhaust air and noise from the printer 1 is not directly directed to the desk. A reduction in the noise in the vicinity of the desk can be achieved by the cover 14.

For example, when the printer 1 is installed at the corner of a wall even near the desk, as illustrated in FIG. 5, the opening portion 21 of the cover 14 is caused to face the left direction which is the arrow y direction, or the opening portion 21 of the cover 14 is caused to face the right direction which is the arrow z direction as illustrated in FIG. 6. Whether the opening portion 21 of the covert 14 is caused to face to the left or to the right is determined by, for example, the direction of the wall on the side. By screwing the cover 14 to the duct hole 12 in an arbitrary direction, the direction of exhaust air and noise can be easily changed to a direction desired by a user, so that a reduction in noise can be achieved.

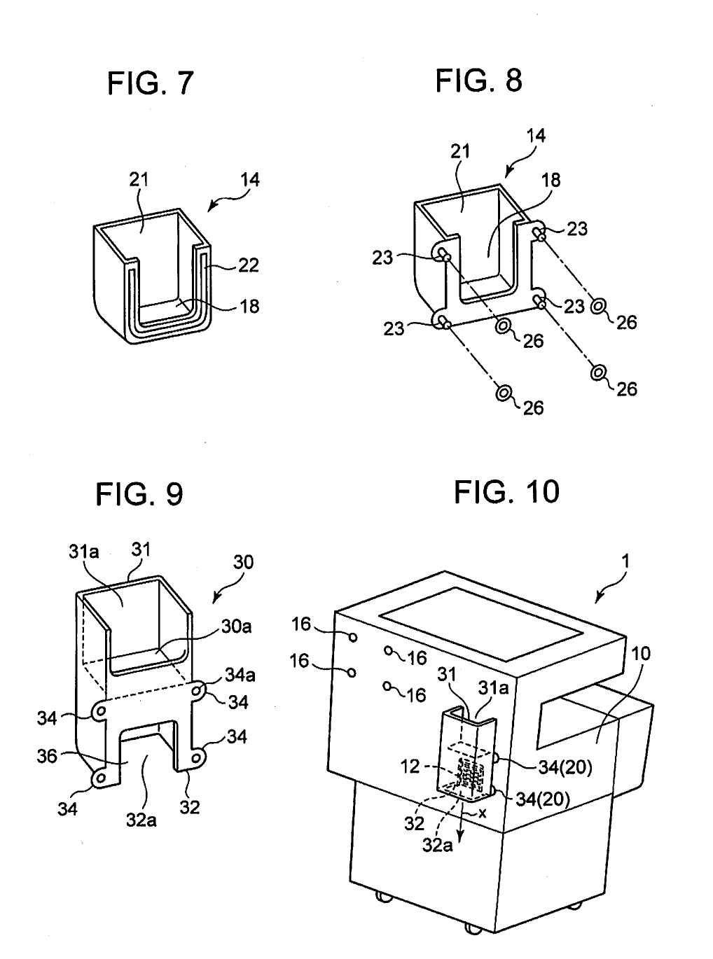

As the attaching portion for the cover 14, instead of the screw unit 19, an adhesive tape may also be used. For example, as illustrated in FIG. 7, in the vicinity of the cut-out portion 18 of the cover 14, an adhesive tape which is repeatedly attachable and detachable is attached. With the demand of the user, the adhesive tape 22 of the cover 14 is removed from the pocket position such that the cover 14 is detached from the housing 10. The detached cover 14 is set to be in the desired direction in the vicinity of the duct hole 12 and is affixed by the adhesive tape 22, thereby changing the direction of the exhaust air and noise from the duct hole 12.

Furthermore, the attaching portion of the cover 14 may also be a fit-in type. For example, perforated washers made of an elastic material such as urethane are attached to the positions of the screw holes 16 and the screw holes 20 of the housing rear side 10a. As illustrated in FIG. 8, bosses 23 fitted to the holes of the washers are formed integrally with the cover 14. With the demand of the user, the bosses 23 of the cover 14 are pulled out from the washers at the pocket position such that the cover 14 is detached from the housing 10. The detached cover 14 is set to be in the desired direction in the vicinity of the duct hole 12, and the bosses 23 of the cover 14 are fitted to attach the cover 14 to the duct hole 12.

According to the first embodiment, the cover 14 detached from the pocket position with the demand of the user is screwed to the vicinity of the duct hole 12 by selecting the direction of the opening portion 21 of the cover 14. Only by moving and attaching the cover 14, the direction of the exhaust air and noise from the duct hole 12 can be easily changed. Suitable environment settings for the office can be easily obtained according to the use environment of the printer 1, and a reduction in noise can be obtained.

Moreover, when the attaching portion of the cover 14 is configured as the adhesive tape or the fit-in type, even without the use of tools for attaching and detaching the screw 17, the direction of the exhaust air and noise from the duct hole 12 can be easily changed.

### Second Embodiment

Next, a second embodiment will be described. The second embodiment is different from the first embodiment described above in the shape of the cover. According to the second embodiment, like elements which are the same as those of the configuration described above according to the first embodiment are denoted by like reference numerals, and detailed description thereof will be omitted. In the second embodiment, the cover is caused to have both the duct function and the pocket function when the cover is attached to the housing.

In the second embodiment, as a pocket-and-duct, a cover 30 as illustrated in FIG. 9 is used. The cover 30 has a pocket 31 and a duct 32 with a partition 30a interposed between the pocket 31 and the duct 32 substantially at the center. The duct 32 of the cover 30 has four pedestals 34 each of which has a screw hole 34a. The four screw holes 34a form a square. The cover 30 is made of plastic and is formed integrally with the pedestals 34. The cover 30 has a cut-out portion 36 which is a conduction portion on the attaching side of the housing 10.

By the screws 17, as illustrated in FIG. 10, the pedestals 34 of the cover 30 are screwed to the screw holes 20 in the vicinity of the duct hole 12 of the housing rear face 10a. In the cover 30, when a duct opening 32a of the duct 32 faces the downward direction (floor direction) which is the arrow x direction, a pocket opening 31a of the pocket 31 faces upward. In the cover 30 attached to the duct hole 12, materials are put as needed.

Heat and noise inside the housing 10 that is generated by driving the printer 1 passes through the cut-out portion 36 from the duct hole 12, and the direction of heat and noise is changed to the downward direction (the floor direction) along the inner wall of the duct 32.

By attaching the cover 30 to the duct hole 12, for example, even when the printer 1 is installed near the desk in the office, the exhaust air and noise from the printer 1 is not directly directed to the desk. Therefore, the noise in the vicinity of the desk can be reduced. In addition, when the exhaust air and noise is caused to face the downward direction (the floor direction) , materials can be put in the pocket 31 of the cover 30.

In addition, due to an office environment, when there is a demand to cause the duct opening 32a of the cover 30 to face the left direction or the right direction, the screws 17 are unscrewed from the screw holes 20 in the vicinity of the duct hole 12 such that the cover 30 is temporarily detached from the housing rear side 10a. The direction of the cover 30 detached from the housing rear side 10a is changed, and the cover 30 is then screwed to the screw holes 20 in the vicinity of the duct hole 12 again. The direction of the exhaust air and noise from the duct hole 12 passes through the cut-out portion 36 and is changed to the left direction or the right direction of the housing 10 along the inner wall of the cover 30. Whether the opening portion of cover 30 is caused to face to the left or right is determined by the demand and the determination can be easily changed, thereby obtaining a noise reduction.

In addition, for example, when the printer 1 is disposed at a position distant from the desk, there is no need to attach the cover 30 to the duct hole 12. When the cover 30 is dedicated to the use of the pocket function, the cover 30 may be disposed at an upper portion of the printer 1 for usability. When the cover 30 is dedicated to the pocket function, the cover 30 is attached to the screw holes 16 at the pocket position which is at the upper portion of the housing rear side 10a while the pocket opening 31a faces upward.

According to the second embodiment, when the direction of the opening portion 32a of the duct 32 of the cover 30 is caused to face the downward direction (the floor direction) which is the arrow x direction to reduce noise, materials can be put in the pocket 31. Therefore, the cover 30 can be provided with both the function of changing the exhaust direction and the pocket function. Moreover, the direction of the opening portion 32a of the duct 32 can be changed only by moving and attaching the cover 30 with the demand of the user or the like, so that the direction of the exhaust air and noise from the duct hole 12 can be easily changed. Suitable environment settings for the office depending on the use environment of the printer 1 can be easily obtained, and the noise reduction can be achieved.

According to at least one of the embodiments, depending on the use environment of the printer, the pocket-and-duct is detached from the housing and moved to be attached to the housing again, so that suitable environment settings for the office can be easily obtained and the reduction in noise in the office can be achieved.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. An image forming apparatus comprising:
a housing including an exhaust port;
a pocket-and-duct which is attached to or detached from the housing; and
an attaching portion of the pocket-and-duct.

2. The apparatus according to claim 1, wherein the pocket-and-duct is attachable to or detachable from a pocket position of the housing and the exhaust port.

3. The apparatus according to claim 1, wherein the pocket-and-duct changes an exhaust direction by changing an attaching direction of the pocket-and-duct to the exhaust port.

4. The apparatus according to claim 3, wherein the pocket-and-duct causes the exhaust direction from the exhaust port to be changed to any of an upward direction, a downward direction, a left direction, and a right direction of the housing.

5. The apparatus according to claim 1, wherein the pocket-and-duct includes a conduction portion for a conduction of air exhausted from the exhaust port on an attaching side of the housing.

6. The apparatus according to claim 1, wherein the pocket-and-duct includes a pocket and a duct with a partition interposed between the pocket and the duct.

7. The apparatus according to claim 6, wherein the pocket-and-duct causes the exhaust direction of the duct to face downward so that a pocket is provided above the partition when the pocket-and-duct is attached to the exhaust port.

8. The apparatus according to claim 1, wherein the attaching portions are disposed at four corners of a square in the vicinity of the exhaust port and at a pocket position of the housing.

9. The apparatus according to claim 1, wherein the attaching portion is a screw unit that fastens the pocket-and-duct to the housing.

10. The apparatus according to claim 1, wherein the attaching portion is an adhesive tape which affixes the pocket-and-duct to the housing.

11. The apparatus according to claim 1, wherein the attaching portions are fitting members used for fitting the pocket-and-duct in the housing.

12. A method of changing an exhaust direction of an image forming apparatus, comprising:
attaching a pocket-and-duct which is attachable to and detachable from a housing to an exhaust port of the housing.

13. The method according to claim 12, wherein the pocket-and-duct is detached from a pocket position of the housing and is attached to the exhaust port.

14. The method according to claim 12, further comprising a attaching direction of the pocket-and-duct attached to the exhaust port is changed so as to change an exhaust direction from the exhaust port.

15. The method according to claim 14, wherein the exhaust direction from the exhaust port is changed to any of an upward direction, a downward direction, a left direction, and a right direction of the housing.

16. The method according to claim 12, wherein the pocket-and-duct has a pocket at the upper portion so that the exhaust direction from the exhaust port faces downward from the housing when the pocket-and-duct is attached to the exhaust port.

17. The method according to claim 12, wherein the pocket-and-duct is screwed to the housing.

18. The method according to claim 12, wherein the pocket-and-duct is adhered to the housing.

19. The method according to claim 12, wherein the pocket-and-duct is fitted to the housing.
